(19) United States
(12) Patent Application Publication
(10) Pub. No.: US 2003/0065588 A1
(43) Pub. Date: Apr. 3, 2003

(54) Identification and presentation of analogous beauty case histories

(76) Inventor: Gilles Rubinstenn, Paris (FR)

Correspondence Address: FINNEGAN, HENDERSON, FARABOW, GARRETT & DUNNER, L.L.P., 1300 I Street, N.W., Washington, DC, 20005-3315, US

(21) Appl. No.: 10/024,332

(22) Filed: Dec. 21, 2001

Related U.S. Application Data
(60) Provisional application No. 60/325,559, filed on Oct. 1, 2001.

(51) Int. Cl. G06F 17/60

(52) U.S. Cl. 705/27

(57) ABSTRACT

Methods and systems are provided for assisting a subject in selecting a beauty product. In accordance with an embodiment, a method may include maintaining a plurality of sets of time-lapse body images for a plurality of individuals. In addition, an identity of at least one beauty product used by each of the plurality of individuals during the time-lapse may be associated with each of the plurality of sets of time-lapse body images. Moreover, selection information may be received for matching the subject with at least at least one individual portrayed in a maintained set of time-lapse body images. Then, based on the selection information, at least one set of time-lapse images of the at least one individual may be displayed to the subject. An identification of at least one beauty product used during the time-lapse by the at least one individual may also be presented to the subject.

### BACKGROUND OF THE INVENTION

1. Field of the Invention

The invention relates to methods, systems, and articles of manufacture for identifying and presenting analogous beauty case histories. In one example, systems and methods consistent with the invention may assist a subject in making a beauty product purchasing decision based on past product-usage experiences of others.

2. Description of Related Art

Although the invention, in its broadest sense, is not limited to beauty products, this patent uses beauty products for purposes of conveying to the reader some of the principles of the invention. As used herein, the term “beauty product” generally refers to any product that may be used by a subject for a beauty purpose. Such products may include, but are not limited to, anti-aging compounds, elasticity enhancers, hair coloring products, moisturizers, tanners, anti-wrinkle agents, blushes, mascaras, eyeliners, lip liners, lipsticks, lip glosses, eyebrow liners, eye shadows, nail polishes, foundations, concealers, dental whitening products, cellulite reduction products, shampoos, conditioners, hair straightners and curlers, weight reduction products, and any other cosmetic or other product that affects a subject's appearance.

Beauty product purchasing decisions may be complex. Consumers in search of a product for treating a particular beauty condition may encounter scores of products each promising the desired result. Representations of effectiveness are often presented on product packaging, in paid media advertisements, and through celebrity endorsements. And with the advent of the Internet, a host of electronic commerce channels now pitch beauty products. At the same time, media reports of false promises and personal experiences with ineffective products have made skeptics out of many consumers.

Products purporting to accomplish the same or similar results are sold at differing price points, and some consumers assume a correlation between the price of a product and its effectiveness. But, as a general rule, such a correlation does not necessarily exist. Therefore, consumers persuaded to purchase an expensive yet ineffective product, might lose confidence in an entire category of products. Thus, the task of identifying the effective product in a sea of ineffective or marginally effective products is a deterrent to beauty product purchases.

Even when a product is proven effective, effectiveness may vary from user to user. For example, a particular anti-wrinkle cream may work exceptionally well on one type of skin but might have limited effectiveness on another. Subjects lack tools for determining in advance whether they will respond positively to a product having an effectiveness that varies based on personal attributes of each user.

Beauty consultants with significant experience may facilitate the selection of an effective beauty product. However, employing beauty consultants in the beauty product selection process is labor intensive, and the ability to consummate a product sale may at least in part be a function of the customer's confidence and trust in the consultant.

### SUMMARY OF A FEW ASPECTS OF THE INVENTION

In one respect, the invention may assist a subject in selecting at least one beauty product, with the aid of a maintained archive of sets of time-lapse body images. The archive may also identify beauty product usage associated with such set of time-lapse images. Moreover, selection information may be received for matching the subject with at least one individual portrayed in a maintained set of time-lapse body images. Then, based on the selection information, at least one set of time-lapse images may be displayed to the subject. An identification of a beauty product used during the time-lapse by the individual may also be presented to the subject.

According to another aspect of the invention, information about the subject's external condition may be collected. Based on the collected information, a prognosis may be generated. The subject may then be presented with experiences of at least one individual having a prognosis similar to subject's prognosis. The information may include at least one of lifestyle information, age, skin type, skin tone, and beauty product usage information. The subject may also be presented with time-lapse image of the at least one individual.

A third aspect of the invention may include a method of assisting a subject in determining how personal experience might impact at least one external condition of the subject. The method may include collecting subject information about at least one external condition of the subject, based on the collected subject information, selecting a record of experiences of at least one other individual whose record contains information relating to the at least one external condition, and presenting to the subject information from the selected record, the information including personal experience of the at least one other individual. The personal experience may be textually presented as a story about life experiences of other individuals.

A fourth aspect of the invention may be a method of assisting a subject in selecting at least one beauty product. The method may include maintaining a plurality of sets of time-lapse information for a plurality of individuals, enabling the subject to select at least one of said plurality of individuals, displaying to the subject at least one set of time-lapse information corresponding to the at least one selected individual, and displaying to the subject personal information about a lifestyle of the at least one selected individual.

A fifth aspect of the invention may be a method of assisting a subject in determining how personal experience might impact the subject's appearance. The method may include maintaining a plurality of sets of time-lapse body information for a plurality of individuals, enabling the subject to select at least one of the individuals, and displaying to the subject the time-lapse body information relating to the at least one selected individual.

As described hereafter, the invention is multifaceted. Thus, the preceding summary of a few aspects of the invention is exemplary only and is not to be interpreted as defining the invention.

### BRIEF DESCRIPTION OF THE DRAWINGS

FIG. 1 illustrates an exemplary screen shot summarizing a beauty case history, consistent with methods and systems of the present invention;

FIG. 2A illustrates a flow chart of an exemplary method of assisting a subject in selecting at least one beauty product consistent with an embodiment of the present invention;

FIG. 2B illustrates an exemplary screen shot presenting lifestyle information consistent with features and principles of the present invention;

FIG. 3 illustrates an example of questionnaire a vendor may use to obtain information about an individual, consistent with methods and systems of the present invention;

FIGS. 4-6 are exemplary screen shots that may be presented to a subject, consistent with methods and systems of the present invention;

FIG. 7 is block diagram of an exemplary system environment, in which the invention may be practiced;

FIG. 8 is an exemplary block diagram of a computer consistent with methods and systems of the present invention;

FIG. 9 is a flowchart illustrating exemplary steps of a collection process consistent with methods and systems of the present invention;

FIG. 10 is a flowchart illustrating exemplary steps of an analysis process consistent with methods and systems of the present invention; and

FIG. 11 is a flowchart illustrating exemplary steps of a prognosis process consistent with methods and systems of the present invention.

### DESCRIPTION OF EXEMPLARY EMBODIMENTS

In the foregoing description of exemplary embodiments, reference will be made to the accompanying drawings in which like numerals may represent the same or like elements.

Methods and systems consistent with the present invention may assist a subject in selecting a beauty product based on analogous beauty case histories. In one respect, the invention may allow a consumer to view case histories of other individuals who share traits with the consumer. In this way, the consumer may be provided with a tool for determining how the use and/or non-use of beauty products might effect the consumer's own appearance.

A beauty case history may include any information that identifies personal characteristics of an individual. Such information may include a collection of time-lapse body images, such as pictures, movies or any type of multimedia files, of an individual and personal information about the individual. Time-lapse images may include images separated by days, weeks, months, or even years. The images may include images of an individual before and after application of a beauty product. Personal information may further/alternatively include one or more of personal characteristics (physical, physiological, biological, and aesthetic), such as age, skin type, and skin tone; lifestyle information, such as eating habits and life experiences; demographic information, such as information about the geographic location of the individual's residence; environmental information, such as sun exposure habits; nutritional information; medical history information, such as prognosis information; beauty product usage information, such as information about at least one beauty product used by the individual; dietary supplement usage; and other personal information about the individual.

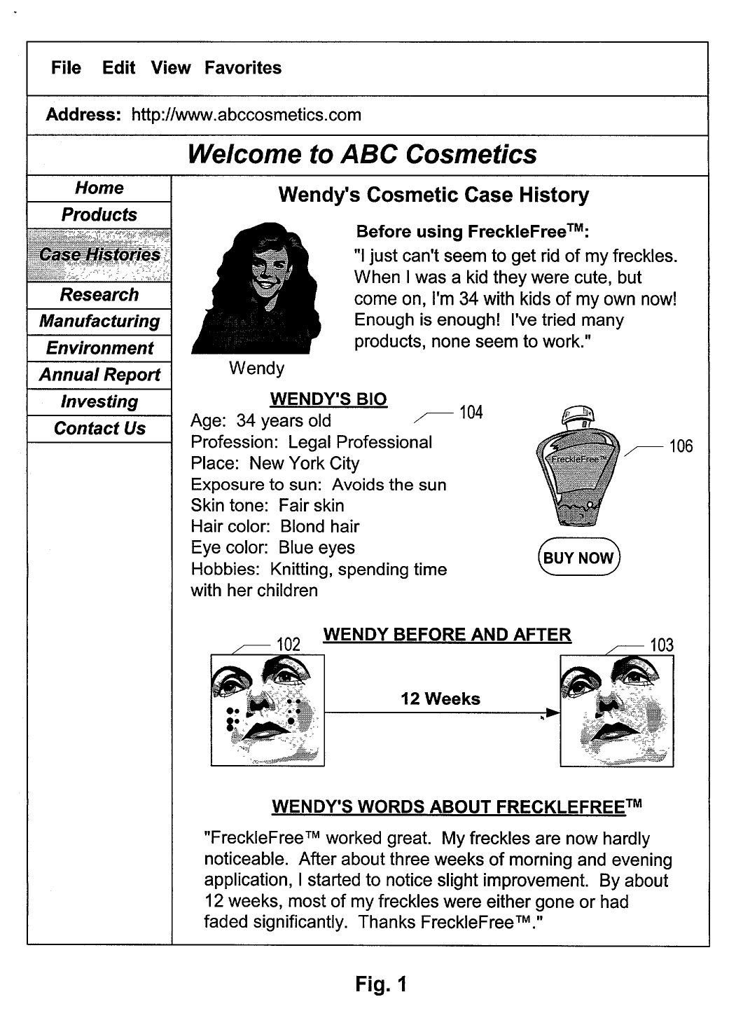

FIG. 1 is a screen shot summarizing an exemplary beauty case history. In this example, the case history may include time-lapse body images 102 and 103, and personal information 104 about the individual. In addition, the case history may include an optional button 106 so that the subject may purchase the beauty product shown in the case history.

By way of example, a system may maintain a collection of beauty case histories for a plurality of individuals. A subject may use a processor in the system to help identify from the plurality of individuals at least one individual having at least one trait, similar to one of the subject's own traits. Once the at least one individual is identified, the system may display to the subject personal information about the individual, such as time-lapse body images. The system may also allow the subject to review one or more beauty products used by the identified individual during the time-lapse. In addition, the system may allow the subject to purchase the beauty product used by the identified individual.

The preceding discussion is intended to provide an exemplary overview of the invention. Further details and other examples follow. However, it is to be understood that other alternative embodiments may be utilized and that structural and method changes may be made without departing from the scope of the present invention. The foregoing and following discussion are, therefore, not to be construed in a limiting sense.

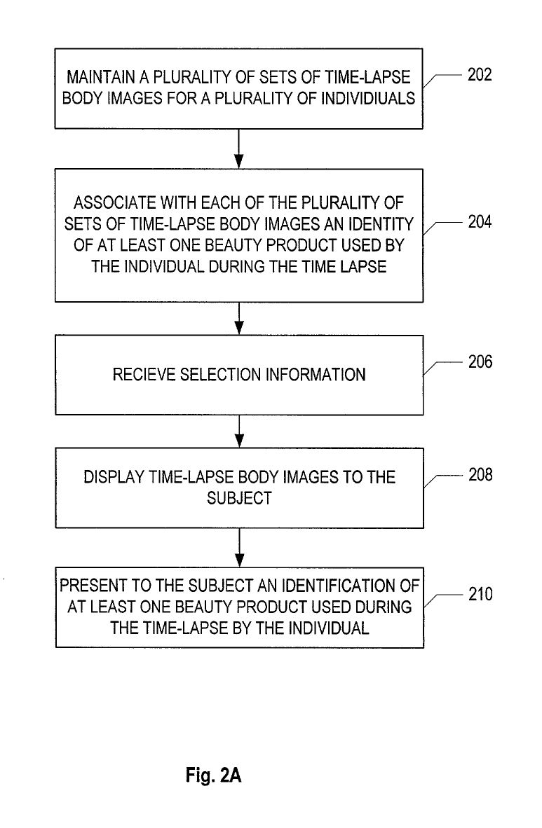

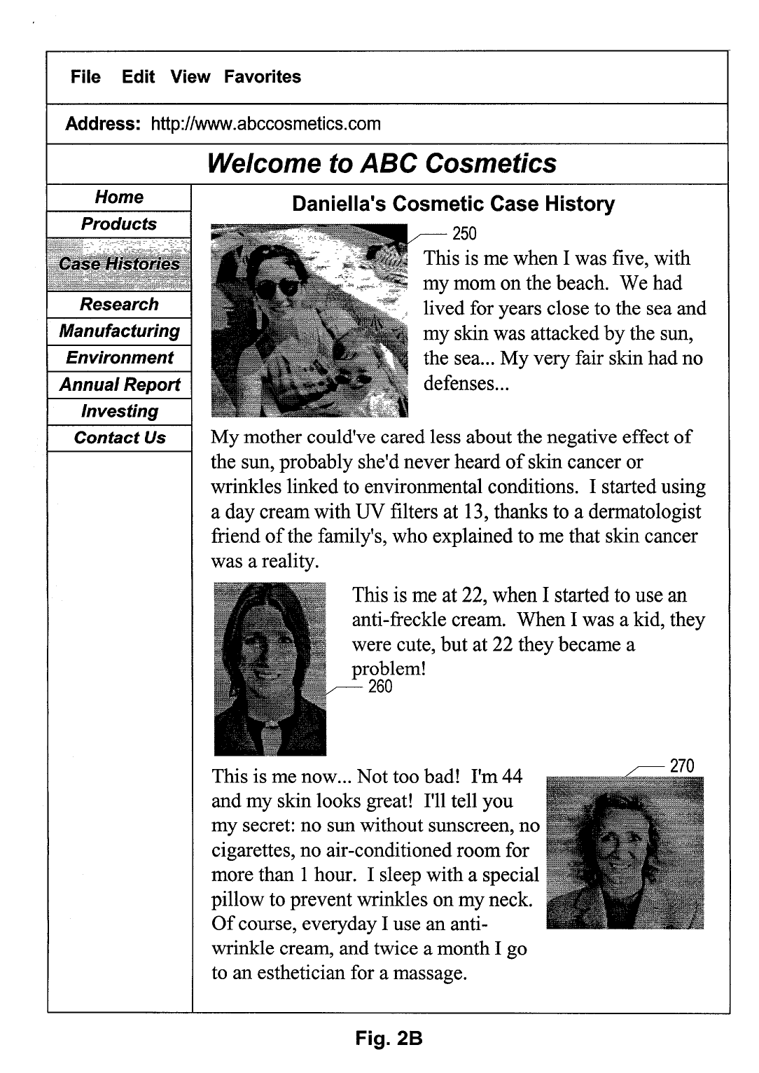

One embodiment of the invention may include a method of assisting a subject in selecting at least one beauty product. FIG. 2A illustrates an exemplary flow chart of such a method. The method may include maintaining a plurality of sets of time-lapse body images for a plurality of individuals (step 202). The images may be maintained manually, for example, in a printed catalog, or in a database on a computer or on a server.

A set of time-lapse body images for an individual may include an image of an individual before application of a beauty product and an image of the individual after application of the beauty product. The time-lapse between the images may include any time-lapse such as a day, a week, a month, or a year. The images may include pictures or multimedia files. Moreover, the images may be actual or simulated images. Simulated images may include wholly or partially generated computer images, images based on existing images, and images based on stored features of an individual. The images may include images of one or more body parts exhibiting an external condition, such as wrinkles. Thus, the images may include facial images or images of other body parts of the individual.

The method may also include associating with each of the plurality of sets of time-lapse body images an identity of the at least one beauty product used by an individual during the time-lapse (step 204). For example, the name of the product may be associated with each of the plurality of sets of time-lapse body images. As used herein, the term product may include packaged goods as well as beauty services such as those performed in salons, spas, and other beauty case facilities.

Although not shown in FIG. 2A, the method may also include maintaining personal information about the plurality of individuals. Like the images, personal information may be maintained manually or on a computer. As described earlier in more detail, personal information may include personal characteristics; lifestyle information; demographic information; environmental information, etcetera.

Lifestyle information may include life experiences of an individual. FIG. 2B illustrates an exemplary screen shot presenting life experiences in the form of a case history. The life experiences may be textually presented as a story about the individual's life or may be presented as case history information in any other manner. Time-lapse images 250, 260, and 270 may also be used to help convey different aspects of the individual's life experiences.

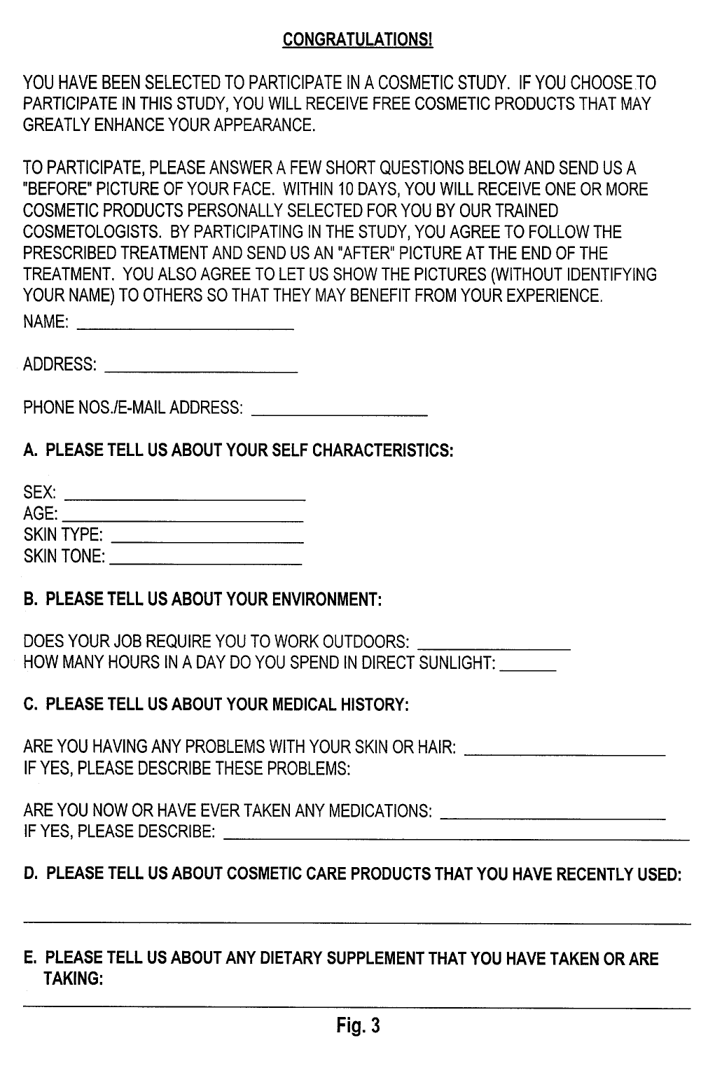

The time-lapse body images and information about individuals, including beauty product information, may be collected and maintained in a variety of ways, including electronically and manually. For example, as explained in more detail below, a collection process may be used to electronically collect and maintain images and information about individuals. This collection may occur while the consumer is located at home or office. Alternatively, the images and information may be collected at a salon or other facility not controlled by the individual. The images and information may also be collected via physical mail or e-mail, for example, by sending questionnaires to selected individuals. An example of a first part of such a questionnaire is shown in FIG. 3. As shown, the questionnaire may include a series of questions that ask the individual to supply various items of information, such as personal characteristics information, demographic information, environmental information, medical history information, beauty product usage information, dietary supplement use information and other personal information about the individual. The questionnaire may also ask the individual for an image and may include specifications for the image, such as lighting conditions and size.

Consistent with the invention, the method may also include receiving selection information for matching the subject with at least one individual portrayed in a maintained set of time-lapse body images (step 206). The selection information may be received directly from the subject or indirectly from another person, such as an agent of the subject. Selection information may include identity of an external body condition, such as wrinkles; the identity of a beauty product of interest to the subject, and/or information about the subject, such as information from the categories of personal information previously described. Selection information may be received via an input device on a computer, or through any other mechanism, be it electronic or hard copy.

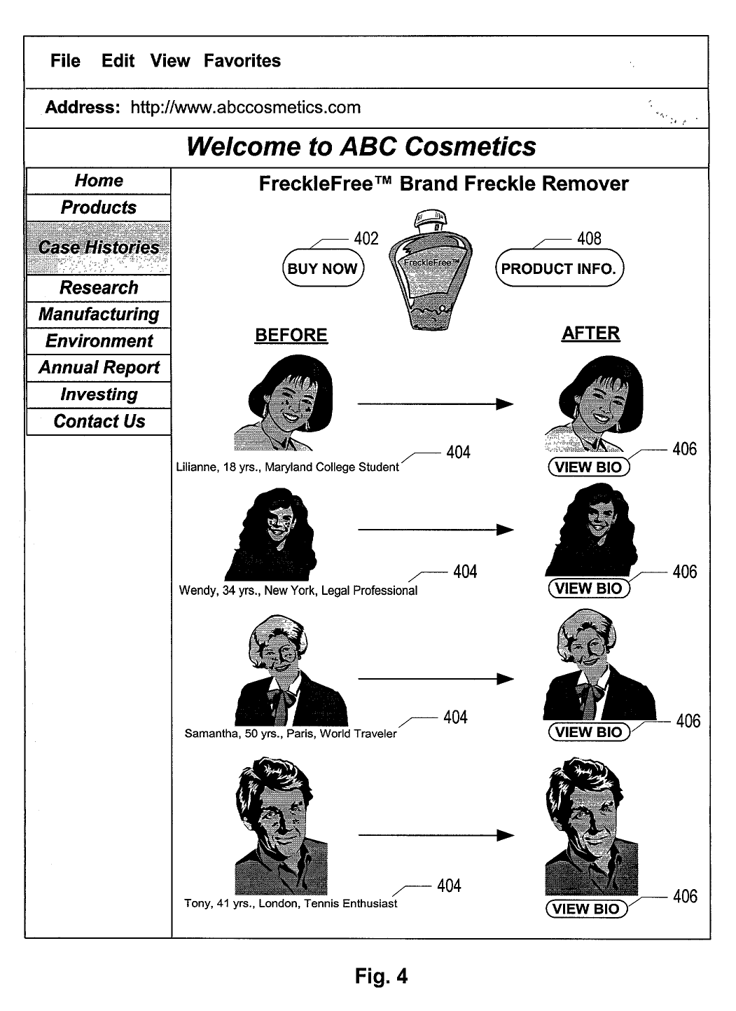

A method consistent with the invention may also include displaying to the subject the at least one set of time-lapse body images of the at least one individual (step 208). For example, if the selection information includes the name of a beauty product, the subject may be presented with time-lapse body images of persons who have used the specified beauty product. An exemplary display is shown in FIG. 4. Although illustrated as a web page, the exemplary information presented in FIG. 4 may be presented in the form of a printed catalog, or any other form of electronic or hard copy display. Moreover, before presenting the page shown in FIG. 4, the subject may be asked to provide answers to a series of questions so that individuals who have characteristics or traits similar to the subject are selected for display.

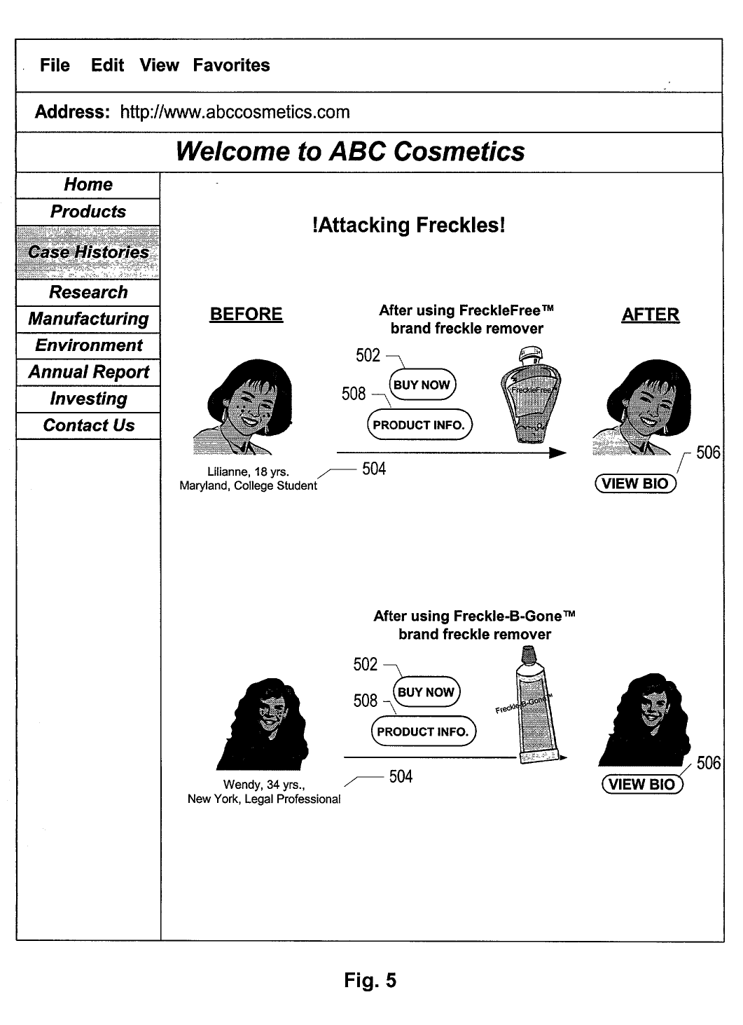

On the other hand, if the selection information includes the identity of an external condition, such as wrinkles, the subject may be presented with time-lapse body images of persons with the specified external condition and products that these individuals have used. An exemplary display is shown in FIG. 5. Like FIG. 4, the information of FIG. 5 may be presented in electronic or hard copy form. Moreover, as with FIG. 4, before presenting the information shown in FIG. 5, the subject may be asked to provide answers to a series of questions to better match the images for display with the characteristics of the subject.

Alternatively, if the selection information solely includes personal information about the subject, a search process may employ a search engine to find individuals with similar characteristics to the subject. After receiving the information about the subject, the search engine may search a database to find and display to the subject at least one set of time-lapse body images of an individual who has characteristics similar to the subject. The displayed page may look similar to the pages shown in FIGS. 4 and/or 5.

Consistent with the invention, the method may also include presenting to the subject an identification of at least one beauty product used during the time-lapse by the at least one individual (step 210). For example, as shown in FIGS. 4 and 5, the beauty product may be identified by one or more of text and product image.

The displayed pages shown in FIGS. 4 and 5 may include various features and may allow the subject to perform various tasks. For example, the subject may select the “BUY NOW” option 402 or 502 on the presented page to electronically purchase the product. A purchase process, as described in the foregoing description, may process the purchase request. The pages may present brief information 404 or 504 about the individuals. The subject may, however, also view more information about the individuals presented on these pages, for example, by selecting the “View Bio” option 406 or 506. The subject may also obtain more information about the product by selecting the “Product Info” options 408 or 508.

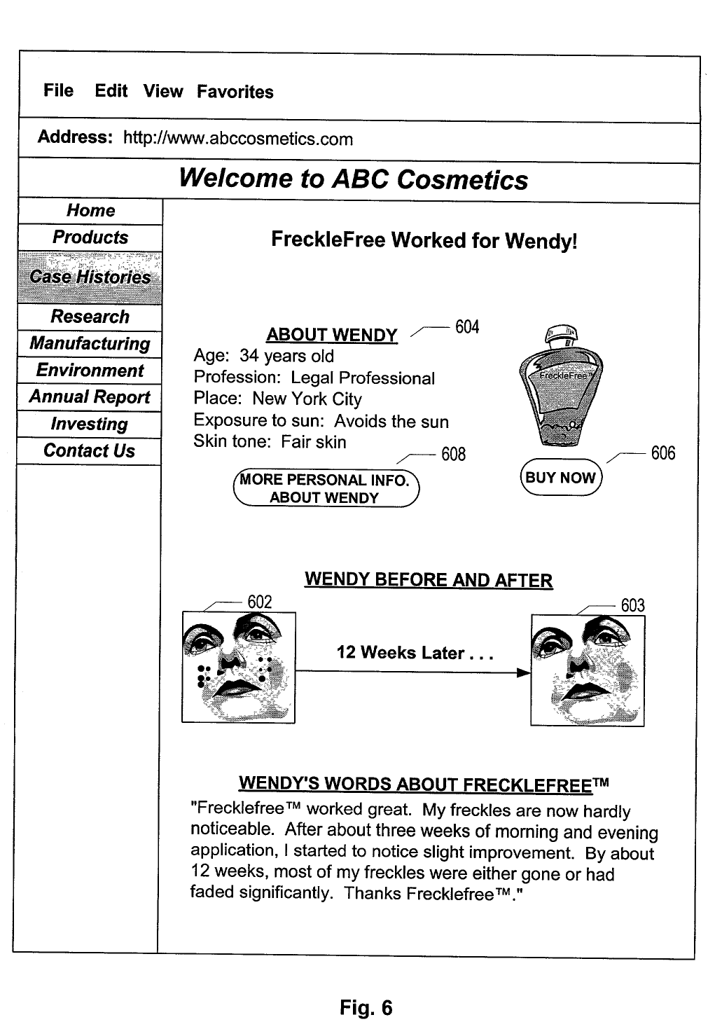

If the subject selects the “View Bio” option 406 or 506, the subject may be displayed a page similar to the page shown in FIG. 6. As shown, the page may include time-lapse body images 602 and 603, more information 604 about the selected individual, an option 606 to buy the product, and an option 608 to view more personal information about the selected individual. If the subject selects option 608, the subject may be displayed a page similar to the page shown in FIG. 1, with a more complete case history on the individual. It may present time-lapse body images 102 and 103, personal information 104, including information about the beauty product used by the individual, and an option 106 to buy the product. If the subject selects option 606 or 106, a purchase process, as described in the foregoing description, may complete the purchase request.

The method may also include maintaining and displaying case histories of individuals who did not apply the beauty product. Displaying case histories of such individuals may allow a subject to get a sense of the consequences of not pursuing a beauty treatment.

In accordance with the invention, the maintaining, associating, receiving, displaying, and presenting steps of the method shown in FIG. 2A may be performed directly or indirectly. Examples of direct performance include maintaining a server that performs or facilitates the function. Examples of indirect performance include entering into a formal or informal relationship with a third party to have the third party perform the function. Another example of indirect performance includes hyperlinking so that users of a website may achieve benefits of the function by clicking through the hyperlinks.

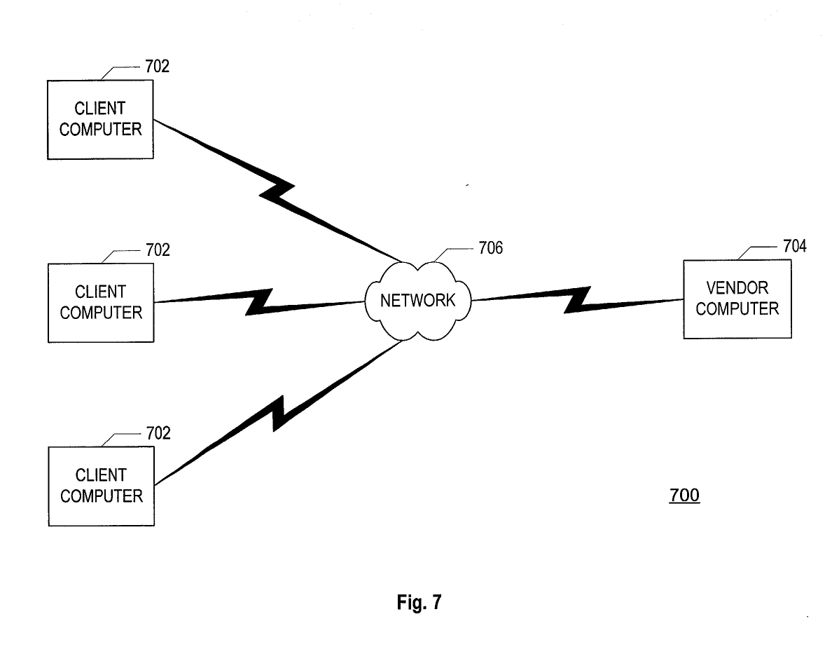

FIG. 7 is an exemplary block diagram of a system 700, in which the invention may be implemented. System 700 may include one or more client computers 702 and a vendor computer 704. Client computer 702 may interface with vendor computer 704 via a network 706. Network 706 may include a Local Area Network (LAN) or a Wide Area Network (WAN). In addition, network 706 may also include a combination of a public network, such as the Internet, and private networks. In its broadest sense, network 706 may include any mechanism for facilitating communication between two nodes or remote locations.

Each client computer 702 may include a computer or any other processor capable of communicating with other computers. Client computer 702 may include a wired or a wireless device, including, but not limited to, a mobile computing device, a cellular phone, and a personal digital assistant (PDA). A user, such as a subject, may use client computer 702 to perform various tasks, including retrieving and viewing analogous case histories stored on vendor computer 704 and purchasing beauty products from vendor computer 704. Client computer 702 may run a browser, such as Internet Explorer or Netscape Navigator to assist the user in performing these tasks, and an image recording device, such as a camera to assist the user in capturing images. Client computer 702 may be located at a subject's home, a vendor's point of sale location, a salon, a spa and other beauty case facilities, a free standing kiosk, or any other location where there may be a desire to dispense beauty information.

Like client computer 702, vendor computer 704 may include a computer or any other processor capable of communicating with other computers. Vendor computer 704 may collect and maintain a plurality of case histories, may assist a subject in selecting a beauty product, may generate a prognosis for a subject, and may sell beauty products of a vendor. A vendor may include a manufacturer, distributor or reseller of beauty products, or any other entity involved in beauty product sales, services, or information distribution.

Other system and network configurations will be apparent to those skilled in the art and are also within the scope of the present invention. For example, system 700 as shown in FIG. 7 may include more than one vendor computer 704 to provide load balancing and fail-over capabilities. Likewise, it will be apparent to one skilled in the art that client computer 702 may perform the functions performed by vendor computer 704 and vice versa. For example, client computer 702 may include processes that perform the functions normally performed by software or processes running on vendor computer 704. Thus, a user may not need to connect to vendor computer 704 to retrieve and view analogous case histories and purchase beauty products. Moreover, it will be apparent to one skilled in the art that the computers shown in FIG. 7 may use various protocols, such as Hypertext Transport Protocol (HTTP) and Transmission Control Protocol/Internet Protocol (TCP/IP) to communicate with each other.

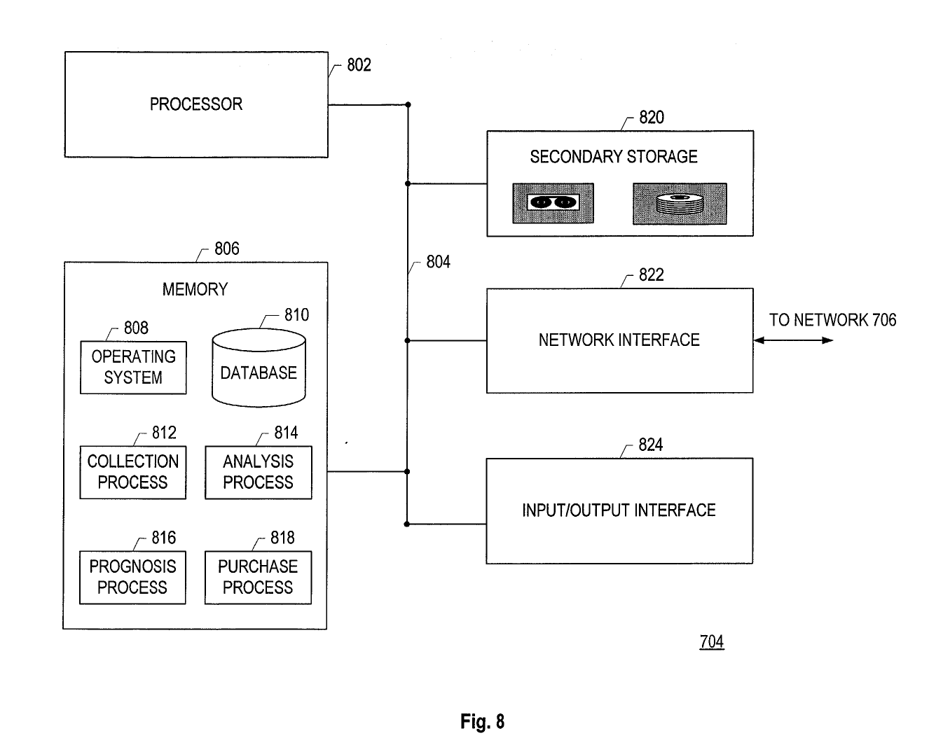

FIG. 8 is an exemplary block diagram of vendor computer 704, in accordance with methods and systems consistent with the present invention. Vendor computer 704 may include a processor 802, which connects via a bus 804 to a memory 806, a secondary storage 820, a network interface 822, and an input/output interface 824.

Memory 806 may include an operating system 808, a database 810, a collection process 812, an analysis process 814, a prognosis process 816, and a purchase process 818. Memory 806 may also include a conventional web server process for hosting a website and a database management system.

Operating system 808 may include, for example, the Windows 2000 operating system available from Microsoft Corporation. Database 810 may include any type of database, such as a relational database. Database 810 may store a variety of information, including beauty case histories for a plurality of individuals, information about beauty products applied to the plurality of individuals or that are being offered for sale, and information about subjects.

Collection process 812, analysis process 814, prognosis process 816, and purchase process 818 may include stored instructions in the form of software, which may be executed by processor 802. Collection process 812 may collect and maintain beauty case histories for a plurality of individuals. Analysis process 814 may retrieve and display analogous case histories from database 810 upon a subject's request. Prognosis process 816 may generate a prognosis based on information collected from a subject about an external condition of the subject and may retrieve and display for the subject beauty case histories of individuals with similar prognoses. Purchase process 818 may include any conventional process that may assist a subject in purchasing products. For example, if network 706 includes the Internet, purchase process 818 may include a conventional shopping cart process.

Secondary storage 820 may comprise a computer readable medium, such as a disk drive, a tape drive and/or flash memory. From a tape drive, for example, software and data may be loaded onto the disk drive, which can then be copied into memory 806. Similarly, software and data in memory 806 may be copied onto the disk drive, which can then be loaded onto the tape drive. It is to be understood that the invention, in its broadest sense does not lie in the mechanisms or manner in which information is stored. Any mechanism or protocol is considered to be with the scope of the invention.

Network interface 822 may transmit messages from vendor computer 704 to other computers, such as client computers 102 and may receive messages addressed to vendor computer 704 from other computers, for example, via network 706. Input/Output interface 824 may include, for example, a keyboard or a key pad and a display unit. Any other tactile and/or voice activated mechanism may be used as an input device in accordance with the invention.

It will be apparent to one skilled in the art that a single process may perform the functions of collection process 812, analysis process 814, prognosis process 816, and/or purchase process 818.

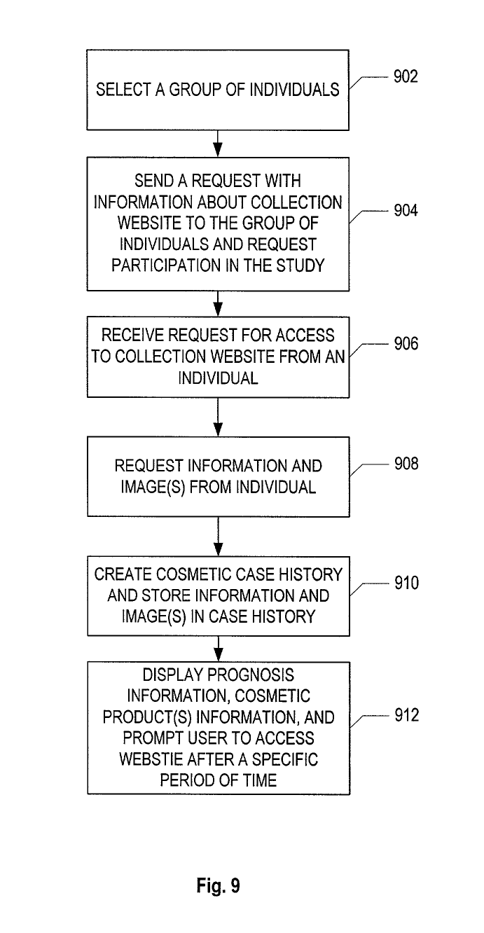

FIG. 9 is a flowchart illustrating exemplary steps that may be performed by collection process 812, in accordance with methods and systems consistent with the present invention. Collection process 812 may select a group of individuals whose beauty case histories will be created and maintained by collection process 812 based on a variety of criteria (step 902). The group of individuals may be selected randomly, from a list of subjects who may have previously purchased a product from the vendor, or based on a variety of factors, such as demographics or personal characteristics.

After the group of individuals have been selected, collection process 812 may send a request to the group of individuals, indicating that the individuals have been selected to be part of a study that the vendor is conducting and that as part of the study, the individuals may receive a promotional item such as a free beauty product, a free service, free advice, a discount coupon, or any other form of incentive (step 904). The request may be sent via physical mail, e-mail, or other methods, such as instant messaging. The request may include information about a collection website, such as the uniform resource locator (URL) corresponding to the website, that may be hosted by vendor computer 704 and that may collect information and images for the case histories and store them in database 810. The request may indicate that if the individual would like to participate in this study, the individual should visit the collection website.

To control access to the collection website, the vendor may require authentication information, such as a user name and password, before an individual is given access to the website. Thus, such authentication information may also be included in the request. In addition, the request may include mention of the previously discussed incentive information to encourage participation in the study.

An individual who desires to participate in the program may use a computer, such as client computer 702, to access the collection website. Vendor computer 704 may receive such an access request and send it to collection process 812 (step 906). Before the individual is given access to the collection website (step 906), however, collection process 812 may require the individual to provide the authentication information that was sent to the individual with the request.

To process the request, collection process 812 may display a web page with a questionnaire that seeks information about the individual and at least one image, such as a photograph, from the individual (step 908). As previously discussed, FIG. 3 shows an example of such a questionnaire. The individual may provide the requested information to collection process 812, for example, by filling out the questionnaire and selecting an area on the web page, such as a submit button, indicating that the individual has finished filling out the questionnaire. The individual may also provide the requested image to collection process 812. To capture the image, the individual may use an image recording device (such as a web cam) connected to client computer 702. Alternatively, the image may be scanned from hard copy or otherwise obtained through any image capture mechanism.

After receiving the information and the image from the individual, collection process 812 may create a case history for the individual and store the information provided by the individual in database 810 (step 910). In addition, collection process 812 may analyze the information, generate a prognosis for an external condition of the individual, and associate the prognosis in the individual's case history. The prognosis information may be used for purposes of recommending to the individual a regimen for treating the external body condition. Prognosis process 816 may generate the prognosis information. If, for example, the survey is retrospective, prognosis information may also be supplied by the individual. Collection process 812 may also assign a unique identifier to the case history.

After processing the information, collection process 812 may display the prognosis information to the individual, recommend at least one beauty product to the individual, and request the individual to access the collection website after a specific period of time to provide more information and at least one time-lapse image after the individual has applied the beauty product for a specific time period (step 912). It is not necessary that the individual have an external condition, such as dry skin. Instead, the vendor may want to investigate the effects of a beauty product and thus may recommend beauty products based on the individual's information, such as skin type. The vendor may send the beauty product or products recommended by collection process 812 to the individual.

When the individual returns to the collection website after the specified time period, collection process 812 may prompt the individual for more information about the individual's condition and may request a new image from the individual (or information sufficient to generate an altered image reflecting progress). After receiving the information, collection process 812 may update the individual's beauty case history. Collection process 812 may repeat this information and image gathering process for a desired amount of time to develop the beauty case histories for the selected group of individuals. For example, repeating this process for a specific amount of time may help the vendor in determining or verifying the effects of the beauty product. To obtain a variety of beauty case histories, collection process 812 may gather information on individuals who did not use a beauty product. Alternatively, placebo products may be dispensed for control purposes.

The vendor may also use other methods to collect and maintain beauty case histories. For example, the vendor may send questionnaires to individuals via physical mail or e-mail. Alternatively, the vendor may use other channels of communication, such as the Internet, television, radio, or telephone, to inform individuals of a study and to obtain participants. Using these channels, individuals may be asked to visit the collection website, call a certain telephone number, or report to a location, such as participating salons, to get more information and to participate in the study. For example, using the Internet, a vendor may place ads on commonly visited web pages, such as websites that include search engines, to increase and encourage participation.

Still another method that the vendor may use to collect and maintain the case histories is simulation. The vendor may obtain an initial image of an individual, for example, through mail, and then use simulation to generate time-lapsed images. These images may reflect the difference in an individual's body condition after application of at least one beauty product. The simulation may be based on, for example, vendor's experience, prior study, or reports received from the individual.

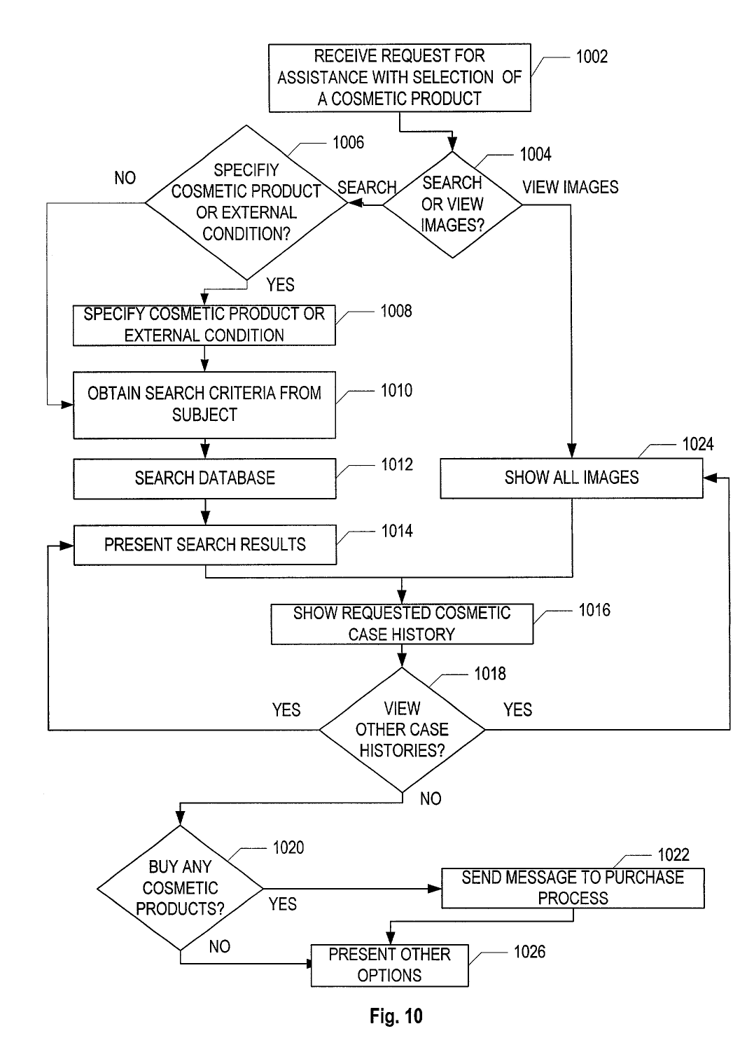

FIG. 10 is a flowchart illustrating exemplary steps that may be performed by analysis process 814, in accordance with methods and systems consistent with the present invention. A subject, using client computer 702, may access vendor computer 704 and may send a request for assistance with selection of at least one beauty product. Upon receiving the request, vendor computer 704 may send the request to analysis process 814 for processing (step 1002). For example, a subject may access a vendor's website and select an area, such as a hyperlink, on the website that allows the subject to place such a request. As a result of the selection, vendor computer 704 may invoke analysis process 814 to process the request.

In response, analysis process 814 may prompt the user to select between searching for beauty case histories or viewing images of all individuals (step 1004). The search case histories option may allow the subject to search for all individuals who have used a particular beauty product or who have a particular external condition. Moreover, this option may also allow a subject to search for individuals who share similar traits, such as personal characteristics, with the subject. The view images option, on the other hand, may allow the individual to view images of all individuals with beauty case histories in database 810.

If the subject selects the searching for case histories option, analysis process 814 may ask the subject whether the subject wants to specify the name of a beauty product or an external condition (step 1006). For example, the subject may have heard about a beauty product and may desire to view case histories of individuals who have used the beauty product. Alternatively, the subject may have an external condition for which the subject wants a beauty product. If the subject chooses to specify a beauty product or external condition, analysis process 814 may receive an identifier from the subject (step 1008). Next, analysis process 814 may optionally prompt the subject for search criteria (step 1010). Specifying a search criteria may assist the subject in limiting the number of case histories presented.

If the subject does not specify the name of a beauty product or external condition, analysis process 814 may prompt the subject for a search criteria (step 1010). The search criteria may depend on the search mechanism used by analysis process 814. For example, analysis process 814 may prompt subject for keywords, such as skin type. Alternatively, analysis process 814 may prompt the subject for certain information, such as personal characteristics information, demographic information, environmental information, medical history information, beauty product usage information, dietary supplement use information, and other personal information.

The subject may enter the search criteria and based on the search criteria, analysis process 814 may search database 810 for beauty case histories (step 1012). If the subject specifies a beauty product or an external condition and specifies a search criteria, analysis process 814 may first select case histories of individuals who have used the specified beauty product or who have the specified external condition and then search that subject of case histories using the specified search criteria. The analysis process 814 may include any conventional search mechanism. Artificial intelligence algorithms may be employed to identify correlations between personal characteristics of subjects and likelihood of success with particular beauty products. Since establishing a feeling of personal connection between the subject and individual(s) portrayed in presented case histories may be a helpful sales tool, artificial intelligence algorithms can also be used to identify individuals with whom the subject is most likely to identify or relate to.

Upon completion of the search, analysis process 814 may display the search results to the subject (step 1014). The search results may include beauty case histories of individuals who applied beauty products recommended by the vendor and those who did not apply beauty products recommended by the vendor so that the subject may compare the two. If database 810 does not include case histories of individuals with characteristics similar to the subject or those who did not apply beauty products recommended by the vendor, analysis process 814 may generate simulated case histories, for example, by altering select case histories for individuals whose characteristics match the characteristics of the subject. In such instance, the initial image prior to treatment may be displayed to the subject.

The search results may be displayed using a variety of methods. For example, the search results may include at least an image of the individual and at least some brief information about the individual, such as age, for all the individuals listed in the search results so that the subject can quickly browse the search results and identify the beauty case histories that the subject desires to view. Examples of such search result pages are shown in FIGS. 4 and 5.

The subject may select a beauty case history that the subject desires to view. In response, analysis process 814 may display the requested beauty case history (step 1016). An example of such a page with a beauty case history is shown in FIG. 6.

On the other hand, if in step 1004, the subject selects the view images option, analysis process 814 may display a gallery of images for all the individuals in database 810 (step 1024). In addition, analysis process 814 may include brief information about the individuals whose images are displayed. Analysis process 814 may either show images of the individuals prior to application of any beauty treatment, images after application of the at least one beauty products, or a combination of both. Before displaying all the images, analysis process 814 may give the subject the option of providing at least some search criteria, such as age.

The subject may select an image that he or she wants to view, and analysis process 814 may in response display the beauty case history corresponding to the image (step 1016).

Because a case history may include information and time-lapse images of the individuals, for example, images of the individual before and after application of at least one beauty product, the case history may assist the subject in selecting a beauty product for his or her body. The case history may also indicate the amount of time-lapse between the displayed images and may also include images and information about the beauty product or products applied to the individual.

The subject may also be given the option of contacting the individual whose case history has been displayed to ask them about his or her experiences with the beauty products. For example, the subject may be given the option of e-mailing the individual. However, the individual's name and e-mail address may remain anonymous to the subject.

After the subject has reviewed the displayed beauty history, analysis process 814 may ask the subject if the subject would like to view other beauty case histories (step 1018). If the subject had selected the search option and if the subject does want to view other beauty case histories, analysis process 814 may loop, displaying the search results and therefore displaying later selected case histories (steps 1018, 1014, and 1016). Alternatively, if the subject had selected the view images option and if the subject chooses to view other beauty case histories, analysis process 814 may loop, displaying the images of all the individuals and therefore displaying later selected case histories (steps 1018, 1024, and 1016).

If the subject does not want to view other beauty case histories (step 1018), then analysis process 814 may ask the subject if the subject would like to purchase any of the beauty products applied to the individuals whose case histories were either displayed in the search results or whose case histories were viewed by the subject (step 1020).

If the subject chooses to buy any beauty products, analysis process 814 may send a signal to purchase process 818 (step 1022). The signal may include information about the beauty products that the subject wants to purchase. After sending the signal, analysis process 814 may allow the subject to perform other tasks by displaying other options, such as viewing information about other beauty products (step 1026). Purchase process 818 may in turn complete the purchase transaction using conventional methods and the product may be sent to the subject. On the other hand, if the subject does not want to purchase any products, the analysis process 814 may allow the subject to perform other tasks by displaying other options to the subject (step 1026).

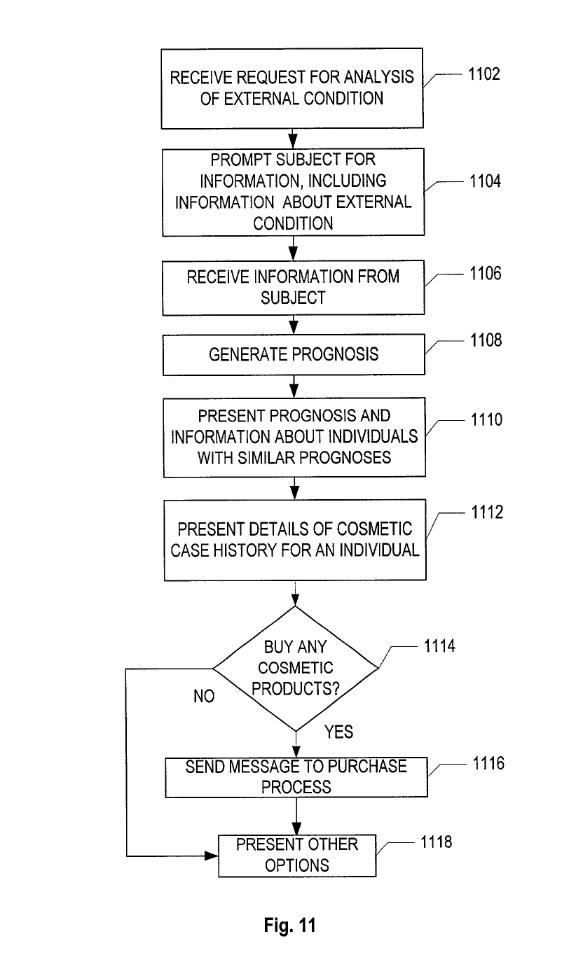

FIG. 11 is a flowchart illustrating exemplary steps that may be performed by prognosis process 816, in accordance with methods and systems consistent with the present invention. Such a configuration may be employed to automatically ascertain the identity and extent of external body conditions. This may be accomplished by applying logic based algorithms to information provided by subject and/or by applying image processing techniques to one or more images provided by the subject. A subject, using client computer 702, may access vendor computer 704 and may send a request for analysis of an external body condition of the subject. Upon receiving the request, vendor computer 704 may send the request to prognosis process 816 for processing (step 1102). For example, a subject may access a vendor's website and select an area, such as a hyperlink, on the website that allows the subject to place such a request. As a result of the selection, vendor computer 704 may invoke prognosis process 816 to process the request.

Prognosis process 816 may request information about the subject (step 1104). The request may prompt for information about the external condition of a body part of the subject,, demographic information, environmental information, medical history information, beauty product usage information, dietary supplement use information, and other personal information. Prognosis process 816 may also prompt the subject for one or more images of the subject's body part with the specified external condition.

In response, the subject may provide the requested information and/or images to prognosis process 816. Prognosis process 816 may receive the information and/or images (step 1106) and may generate a prognosis for the subject based on the information and/or images (step 1110). This may be accomplished with a variety of alternate techniques. For example, if the subject merely provided non-imaged based information, the system might compare that information with information stored on a plurality of individuals to determine a prognosis based on the experiences of others. Artificial intelligence search engines, such as those more fully described in concurrently filed applications may be used to generate prognoses. (See, e.g. concurrently filed application entitled, “System and Methods for Identifying Complementary Products,” Attorney Docket No. 05725.0983, incorporated herein by reference.) Alternatively, one or more images of the subject may be processed to identify a prognosis. Exemplary image processing techniques are described in concurrently filed application entitled, “Feature Extraction from Body Image” [Attorney Docket No. 05728.0978], incorporated herein by reference.

The vendor may have previously stored prognosis information for a plurality of external conditions in database 810. So, prognosis process 816 may generate a prognosis by querying database 810 and including in the query information about the external conditions of the subject. Prognosis process 816 may also use other information, such as personal characteristics, to generate the prognosis.

Next, prognosis process 816 may present to the subject information about the prognosis of the subject, and may retrieve and present to the subject beauty case histories of individuals with prognosis similar to the prognosis of the subject (step 1110). Because only brief descriptions of the beauty case histories may be provided to the subject initially, prognosis process 816 may retrieve and provide details about beauty case histories upon the subject's request (step 1112).

Since the beauty case histories of these individuals may include time-lapse images and a variety of information, including lifestyle information, age, skin type, skin tone, and beauty product usage information, the subject may be able to determine if the subject should purchase beauty product or products used by the individuals. After the subject has viewed the beauty case histories, prognosis process 816 may prompt the subject to determine if the subject desires to purchase any of the products used by the individuals (step 1114).

If the subject chooses to purchase any of the products used by the individuals, prognosis process 816 may send a signal to purchase process 818 for processing (step 1116). The signal may include information about the beauty products that the subject wants to purchase. After sending the signal to purchase process 818, prognosis process 816 may present other options to the subject, such as an option to view other beauty products (step 1118). Purchase process 818 may in turn complete the purchase transaction using conventional methods and the product may be sent to the subject. On the other hand, if the subject does not want to purchase any products, the prognosis process 816 may present other options to the subject (step 1118).

It will be apparent to those of ordinary skill in the art that various modifications and variations can be made in the system and method of the present invention and in the construction of this invention without departing from the scope or spirit of the invention. For example, instead of using analysis process 814, a subject may receive a catalog from the vendor. The catalog may include beauty case histories of individuals and time-lapse images of these individuals. The subject may browse the catalog to identify an individual or individuals having characteristics similar to the subject and obtain information about the beauty products applied to these individuals. If the subject desires to purchase any of the listed products, the subject may fill out a form included in the catalog or order it via telephone.

The above-noted features, other aspects, and principles of the present invention may be implemented in various system or network configurations. Such configurations and applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on the methods and processes of the invention. The media and program instructions may be those specially designed and constructed for the purposes of the invention, or they may be of the kind well-known and available to those having skill in the computer software arts. The media may take many forms including, but not limited to, nonvolatile media, volatile media, and transmission media. Non-volatile media includes, for example, optical or magnetic disks. Volatile media includes, for example, dynamic memory. Transmission media includes, for example, coaxial cables, copper wire, and fiber optics. Transmission media can also take the form of acoustic or light waves, such as those generated during radio-wave and infra-red data communications. Examples of program instructions include both machine code, such as produced by compiler, and files containing a high level code that can be executed by the computer using an interpreter.

This application may discuss beauty products in connection with use by women. However, it is to be understood that such discussions are for exemplary purposes only. It is to be understood that the invention is equally applicable to all genders, and is not necessarily limited to the beauty industry. It is also to be understood that any functional aspect of the invention can be implemented via any location in the system or network, and data software may be resident at any location either in a network, at a stand-alone site, or on media in the custody and control of a user or subject.

It is to be further understood that the physical mechanisms (e.g. hardware, software, networks, systems) for implementing the methods of the invention are many. Networks, hardware and systems can be configured in a host of ways with software and hardware functionality residing at many alternative locations. In addition, systems other than the exemplary systems disclosed might be used to implement the invention. Therefore, it is to be understood that the methods of the invention are not limited to any particular structure.

Further, methods or portions thereof can be implemented in either an electronic environment, a physical environment, or combinations thereof. Thus, for example, although one or more portions of a method may occur in an electronic environment, a “purchase” portion of the method may occur in a brick and mortar store, or vice versa.

### Cross-Reference to Concurrently Filed Applications and Global Definitions

This application claims priority on and incorporates by reference the following U.S. Provisional applications: Artificial Intelligence For Use In Cosmetic And Non-Cosmetic Environments, Application No. 60/325,561 (provisional filed Oct. 1, 2001); and Methods And Systems For Cosmetic And Non-Cosmetic Product Selection, Application No. 60/325,559 (provisional filed Oct. 1, 2001).

The following concurrently filed U.S. patent applications are also incorporated herein by reference: Body Image Enhancement, Attorney Docket No. 05725.0972; Methods And Systems For Predicting And/Or Tracking Changes In External Body Conditions, Attorney Docket No. 05725.0973; Methods And Systems For Generating A Prognosis, Attorney Docket No. 05725.0974; Historical Beauty Record, Attorney Docket No. 05725.0975; Interactive Beauty Analysis, Attorney Docket No. 05725.0977; Feature Extraction In Beauty Analysis, Attorney Docket No. 05725.0978; Simulation Of An Aesthetic Feature On A Facial Image, Attorney Docket No. 05725.0979; Beauty Advisory System And Method, Attorney Docket No. 05725.0980; Virtual Beauty Consultant, Attorney Docket No. 05725.0981; Calibrating Image Capturing, Attorney Docket No. 05725.0982; Use Of Artificial Intelligence In Providing Beauty Advice, Attorney Docket No. 0572.0983; Shop-In-Shop Website Construction, Attorney Docket No. 05725.0984; Early Detection Of Beauty Treatment Progress, Attorney Docket No. 05725.0985; Cosmetic Affinity Indexing, Attorney Docket No. 05725.0986; Systems And Methods For Providing Beauty Guidance, Attorney Docket No. 05725.0987; Methods And Systems Involving Simulated Application Of Beauty Products, Attorney Docket No. 05725.1008; Customized Beauty Tracking Kit, Attorney Docket No. 05725.1009; Analysis Using Three-Dimensional Facial Image Attorney Docket No. 05725.1010; Body Image Templates With Pre-Applied Beauty Products, Attorney Docket No. 05725.1011; and Image Capture Method, Attorney Docket No. 05725.1012.

To the extent not inconsistent with the invention defined herein, definitions and terminology usage in the above-mentioned concurrently filed applications, the above-mentioned priority applications, and the following global definitions are to be considered in interpreting the language of this patent and the claims herein. Where multiple definitions are provided, they should be considered as a single cumulative definition.

The term “image” may include one or more of two-dimensional and three-dimensional representations. In certain examples consistent with the invention, a plurality of images from different perspectives may be used to construct a three-dimensional image. In a broader sense, only a single image may be used. Depending on the embodiment, the term “image” may include either a visually perceptible image or electronic image data that may be either used to construct a visually perceptible image or to derive information about the subject. The image may be a body image corresponding to an anatomical portion of the subject, and may represent, for example, the subject's entire face, or a portion of the subject's face. The image may be a detailed picture (e.g., a digital image or a photograph) of a portion of the subject's body and/or a topological plot mapping contours of a portion of subject's body. If the image is representative of an external body condition, the image could be either an actual image showing the condition or an image including symbolizations of the condition, for example. The image may be an actual or a simulated image. Simulated images may include wholly or partially generated computer images, images based on existing images, and images based on stored features of a subject.

The term “image capture device”, similar terms, and terms representing structures with similar functions may include one or more of a digital camera, webcam, film camera, analog camera, digital video camera, scanner, facsimile machine, copy machine, infrared imager, ultra-sound imaging device, or any other mechanism for acquiring an image of a subject's external body condition, an image of the subject's countenance, an/or an image of the subject's skin. An ultrasonic device might provide skin thickness information, or it might create a map on an area of the external location. Thus, the term “image” as used herein may be broader than a picture. Combinations of image capture devices may be used. For example, an image captured on photographic paper using a film camera might then be scanned on a flat bed scanner to create another image.

The term “capturing (an image)”, or any form thereof, refers to the use of an image capture device to acquire an image. “Capturing” may refer to the direct act of using the image capture device to acquire the image. It may also include indirect acts to promote acquisition. To this end, “capturing” may include the indirect acts of providing access to hardware, or to at least one of a client-based algorithm and a server-based algorithm for causing the image capture device to capture an image. This may be accomplished by providing a user with software to aid in the image capture process, or providing the user with access to a network location at which the software resides. Also consistent with certain embodiments of the invention, capturing may include at least one of receiving an instruction from the subject to capture an image, indicating to the subject before the image is captured, and indicating to the subject when the image is captured.

The term “image processing technique” or similar terms, may include a software program, computer, application specific integrated circuit, electronic device and/or a processor designed to identify in an image one or more characteristics, such as a skin condition. Such techniques may involve binarization, image partitioning, Fourier transforms, fast Fourier transforms (FFTs), and/or discrete cosine transforms may be performed on all or part of the image, resulting in coefficients. Based on the coefficients, conditions may be located, as known in the art. Artificial intelligence, such as fuzzy logic, neural networks, genetic programming and decision tree programming, may also be used to identify conditions. Alternatively, one or more digital filters may be passed through the image for locating specific conditions. These examples are provided for illustrative purposes with the understanding that any image processing technique may be used.

The term “network interface” or similar terms, refer to any mechanism for aiding communications between various nodes or locations in a network. A network interface may include, for example a bus, a modem, or any other input/output structure. A network interface may permit a connection to any network capable of being connected to an input and/or output module located within at least one or more of the following exemplary networks: an Ethernet network, an Internet Protocol network, a telephone network, a radio network, a cellular network, or any mechanism for permitting communication between two or more modes or remote locations. In some invention embodiments, a network interface might also included a user interface.

The term “user interface” may include at least one component such as a keyboard, key pad, mouse, track ball, telephone, scanner, microphone, touch screen, web cam, interactive voice response system (IVR), voice recognition system or any other suitable input mechanism for conveying information. A user interface may also include an input port connected by a wired, optical, or wireless connection for electromagnetic transmissions. In some embodiments, a user interface may include connections to other computer systems to receive the input commands and data therefrom. User interface may further include a data reading device such as a disk drive for receiving input data from and writing data to storage media such as magnetic and optical disks.

As used herein terms such as “external body condition”, “skin condition”, and “actual condition” refer to conditions of at least one of the skin, teeth, hair, eyebrows, eyelashes, body hair, facial hair, fingernails, and/or toenails, or any other externality. Examples of skin conditions may include elasticity, dryness, cellulitis, sweating, aging, wrinkles, melanoma, exfoliation, desquamation, homogeneity of color, creases, liver spots, clarity, lines, micro-circulation, shininess, softness, smoothness, tone, texture, matitty, hydration, sag, suppleness, stress, springiness, firmness, sebum production, cleanliness, translucency, luminosity, irritation, redness, vasocolation, vasomotion, vasodilation, vasoconstriction, pigmentation, freckles, blemishes, oiliness, pore distribution, pore size, moles, birthmarks, acne, blackheads, whiteheads, pockmarks, warts, pustules, boils, blisters, marks, smudges, specks, psoriasis and other characteristics associated with the subject's skin. Examples of hair conditions may include keratin plug, length, dryness, oiliness, dandruff, pigmentation, thickness, density, root conditions, split ends, hair loss, hair thinning, scales, staging, cleanliness and other properties related to the subject's hair. Examples of fingernail and toenail conditions may include onychomycosis, split nails, delaminating, psoriasis, brilliancy, lines, spots, coloration, gloss, strength, brittleness, thickness, hangnail, length, disease, and other characteristics related to the subject's nails. Other conditions may include, for example, size and proportion of facial features, teeth discoloration, and any other aesthetic-related or physical, physiological, or biological conditions of the user.

“Enabling”, “facilitating”, and “causing” an action refer to one or more of a direct act of performing the action, and any indirect act of encouraging or being an accessory to the action. Thus, the terms include partnering or cooperating with an entity who performs the action and/or referring commerce to or having commerce referred from an entity who performs the action. Other examples of indirect activity encompassed within the definitions of “enabling”, “facilitating”, and “causing” may include providing a subject with one or more of tools to knowingly aid in performing the action, providing instructions on how to perform the action, providing prompts or cues to perform the action, or expressly encouraging performance of the action. Indirect activity may also include cooperating with an entity who either directly performs the action or who helps another perform the action. Tools may include software, hardware, or access (either directly, through hyperlink, or some other type of cooperation or partnering) to a network location (e.g., web site) providing tools to aid in performing the action. Thus, phrases such as “enabling access” and “enabling display” do not necessary require that the actor actually access or display anything. For example, the actor may perform the enabling function by affiliating with an entity who performs the action, or by providing instructions, tools, or encouragement for another to do the accessing and displaying.

Forms of the word “displaying” and like terms may also include indirect acts such as providing content for transmission over a network to a display device, regardless of whether the display device is in the custody or control of the sender. Any entity in a chain of delivering information for display performs an act of “displaying”, as the term is used herein.

Likewise, the term “providing” includes direct and indirect activities. For example, providing access to a computer program may include at least one of providing access over a network to the computer program, and creating or distributing to the subject a computer program configured to run on the subject's workstation or computer. For example, a first party may direct network traffic to (either through electronic links or through encouragement to visit) a server or web site run by a second party. If the second party maintains a particular piece of software thereon, then it is to be understood that within the meaning of “providing access” as used herein, the first party is said to provide access to the particular software. Or if the first party directs a subject to a second party who in turn ships the particular software to the user, the first party is said to provide the user with access to the particular software. (Of course, in both of the above instances, the second party would also be providing access within the meaning of the phrase as used herein.) “Receiving” may include at least one of acquisition via a network, via verbally communication, via electronic transmission, via telephone transmission, in hard-copy form, or through any other mechanism enabling reception. In addition, “receiving” may occur either directly or indirectly. For example, receipt may occur through a third party acting on another party's behalf, as an agent of another, or in concert with another. Regardless, all such indirect and direct actions are intended to be covered by the term “receiving” as used herein. A received request, for example, may take one of many forms. It may simply be a checked box, clicked button, submitted form or oral affirmation. Or it might be a typed or handwritten textual request. Receiving may occur through an on-line interest form, e-mail, facsimile, telephone, interactive voice response system, or file transfer protocol transmitted electronically over a network at a web site, an internet protocol address, or a network account. A request may be received from a subject for whom information is sought, or an entity acting on the subject's behalf. “Receiving” may involve receipt directly or indirectly through one or more networks and/or storage mediums. Receipt may occur physically such as in hard copy form, via mail delivery or other courier delivery.

Forms of the word “maintain” are used broadly to include gathering, storing, accessing, providing access to, or making something available for access, either directly or indirectly. For example, those who maintain information include entities who provide a link to a site of a third party where the information is stored.

Consistent with the concepts set forth above, all other recited actions such as, for example, obtaining, determining, generating, selecting, applying, simulating, presenting, etc, are inclusive of direct and indirect actions. Thus, for purposes of interpreting the following claims, an entity performs a recited action through either direct or indirect activity. Further examples of indirect activity include sending signals, providing software, providing instructions, cooperating with an entity to have the entity perform the action, outsourcing direct or indirect actions, or serving in any way as an accessory to the specified action.

The term “product” is used to generically refer to tangible merchandise, goods, services, and actions performed. A “beauty product,” “beauty care product,” “cosmetic product” or similar terms, refer to products (as defined above) for effecting one or more external body conditions, such as conditions of the skin, hair and nails. Examples of tangible merchandise forms of beauty products include cosmetic goods, such as treatment products, personal cleansing products, and makeup products, in any form (e.g., ointments, creams, gels, sprays, supplement, ingesta, inhalants, lotions, cakes, liquids, and powders.)

Examples of services forms of beauty products include hair styling, hair cutting, hair coloring, hair removal, skin treatment, make-up application, and any other offering for aesthetic enhancement. Examples of other actions performed include massages, facial rubs, deep cleansings, applications of beauty product, exercise, therapy, or any other action effecting the external body condition whether performed by a professional, the subject, or an acquaintance of the subject.

The following is exemplary and non-exhaustive listing of a few beauty products-scrubs, rinses, washes, moisturizers, wrinkle removers, exfoliates, toners, cleansers, conditioners, shampoos, cuticle creams, oils, and anti-fungal substances, anti-aging products, anti-wrinkle products, anti-freckle products, skin conditioners, skin toners, skin coloring agents, tanners, bronzers, skin lighteners, hair coloring, hair cleansing, hair styling, elasticity enhancing products, agents, blushes, mascaras, eyeliners, lip liners, lipsticks, lip glosses, eyebrow liners, eye shadows, nail polishes, foundations, concealers, dental whitening products, cellulite reduction products, hair straighteners and curlers, and weight reduction products. A beauty care treatment regimen may involve the administration of one or more products, as defined above.

The terms “beauty advice”, “beauty guidance”, and similar terms are used interchangeably to refer to the provision of beauty related information to a subject. Advice or guidance includes one or more of beauty product recommendations (e.g., cosmetic product recommendations for products to treat conditions the subject is prompted to evaluate), remedial measures, preventative measures, predictions, prognoses, price and availability information, application and use information, suggestions for complementary products, lifestyle or dietary recommendations, or any other information intended to aid a subject in a course of future conduct, to aid a subject in understanding past occurrences, to reflect information about some future occurrences related to the subject's beauty or to aid a subject in understanding beauty products, as defined above.

The term “network” may include a public network such as the Internet or a telephony network, a private network, a virtual private network, or any other mechanism for enabling communication between two or more nodes or locations. The network may include one or more of wired and wireless connections. Wireless communications may include radio transmission via the airwaves, however, those of ordinary skill in the art will appreciate that various other communication techniques can be used to provide wireless transmission including infrared line of sight, cellular, microwave, satellite, blue-tooth packet radio and spread spectrum radio. Wireless data may include, but is not limited to, paging, text messaging, e-mail, Internet access and other specialized data applications specifically excluding or including voice transmission.

In some instances consistent with the invention, a network may include a courier network (e.g. postal service, United Parcel Service, Federal Express, etc.). Other types of networks that are to be considered within the scope of the invention include local area networks, metropolitan area networks, wide area networks, ad hoc networks, or any mechanism for facilitating communication between two nodes or remote locations.

“Artificial intelligence” (AI) is used herein to broadly describe any computationally intelligent systems that combine knowledge, techniques, and methodologies. An Al engine may be any system configured to apply knowledge and that can adapt itself and learn to do better in changing environments. Thus, the Al engine may employ any one or combination of the following computational techniques: neural network, constraint program, fuzzy logic, classification, conventional artificial intelligence, symbolic manipulation, fuzzy set theory, evolutionary computation, cybernetics, data mining, approximate reasoning, derivative-free optimization, decision trees, or soft computing. Employing any computationally intelligent techniques, the Al engine may learn to adapt to unknown or changing environment for better performance. Al engines may be implemented or provided with a wide variety of components or systems, including one or more of the following: central processing units, co-processors, memories, registers, or other data processing devices and subsystems.

Al engines may be trained based on input such as product information, expert advice, user profile, or data based on sensory perceptions. Using input an Al engine may implement an iterative training process. Training may be based on a wide variety of learning rules or training algorithms. For example, the learning rules may include one or more of the following: back-propagation, real-time recurrent learning, pattern-by-pattern learning, supervised learning, interpolation, weighted sum, reinforced learning, temporal difference learning, unsupervised learning, or recording learning. As a result of the training, Al engine may learn to modify its behavior in response to its environment, and obtain knowledge. Knowledge may represent any information upon which Al engine may determine an appropriate response to new data or situations. Knowledge may represent, for example, relationship information between two or more products. Knowledge may be stored in any form at any convenient location, such as a database.

Since AI engine may learn to modify its behavior, information describing relationships for a universe of all combinations of products may not need to be maintained by the Al engine or any other component of the system.

“Personal information”, “subject specific information”, “user specific information”, “user profile”, “personal characteristics”, “personal attributes”, “profile information”, and like terms (collectively referred to in this section as “personal information”) may broadly encompass any information about the subject or user. Such information may, for example, fall within categories such as physical characteristics, fashion preferences, demographics, nutritional information, cosmetic usage information, medical history information, environmental information, beauty product usage information, lifestyle, and may include information such as name; age; birth date; height; weight; ethnicity; eating habits; vacation patterns; geographic location of the individual's residence, location, or work; work habits; sleep habits; toiletries used; exercise habits; relaxation habits; beauty care habits; smoking and drinking habits; sun exposure habits; use of sunscreen; propensity to tan; number of sunburns and serious sunburns; dietary restrictions; dietary supplements or vitamins used; diagnosed conditions affecting the external body, such as melanoma; an image, such as a picture or a multimedia file of the subject; facial feature characteristics; family history information such as physical characteristics information about relatives of the subject (e.g., premature balding, graying, wrinkles, etc.); external body condition (as defined previously); color preferences, clothing style preferences, travel habits; entertainment preferences; fitness information; adverse reactions to products, compounds, or elements (e.g., sun exposure); body chemistry, use of prior beauty care products and their effectiveness; purchasing, shopping, and browsing habits; hobbies; marital status; whether the subject is a parent; country of residence; region of residence; birth country and region; religious affiliation; political affiliation; whether the subject is an urban dweller suburban dweller or rural area dweller; size of urban area in which the subject lives; whether the subject is retired; annual income, sexual preference, or any other information reflecting habits, preferences, or affiliations of the subject.

Personal information may also include information electronically gleaned by tracking the subject's electronic browsing or purchasing habits, or as the result of cookies maintained on the subject's computer, responses to surveys, or any other mechanism providing information related to the subject. In addition, personal information may be gathered through non-electronic mechanisms such as hard copy surveys, personal interviews, or consumer preference polls.

“Complementary” and “complementary product” refers to one or more of physical, physiological, biologically, and aesthetic compatibility. A product may be complementary with one or more of another product, a group of products, or a subject. In that latter instance, whether a product is considered “complementary” may be a function of personal information of the subject. Thus, for example a product may be complementary if it is unlikely to cause an adverse allergic reaction; if it physically blends well with another product; or if it is aesthetically consistent with the subject or one or more other products. Aesthetic compatibly may refer to the fact that two products are aesthetically appealing (or do not clash) when worn together. The identification of a complementary product may also be based on product characteristics, user preferences, survey data, or expert advice.

As used herein, the words “may” and “may be” are to be interpreted in an open-ended, non-restrictive manner. At minimum, “may” and “may be” are to be interpreted as definitively including structure or acts recited. Further, the word “or” is to be interpreted in the conjunctive and the disjunctive.

While flow charts presented herein illustrate a series of sequential blocks for exemplary purposes, the order of blocks is not critical to the invention in its broadest sense. Further, blocks may be omitted and others added without departing from the spirit of the invention. Also, the invention may include combinations of features described in connection with differing embodiments.

Although a focus of the disclosure may be on server-side methods, it is nevertheless to be understood that the invention includes corresponding client-side methods, software, articles of manufacture, and computer readable media, and that computer readable media can be used to store instructions for some or all of the methods described herein. Further, it is to be understood that disclosed structures define means for implementing the functionality described herein, and that the invention includes such means for performing the disclosed functions.

In the foregoing Description of Exemplary Embodiments, various features are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Exemplary Embodiments, with each claim standing on its own as a separate embodiment of the invention.

What is claimed is:

1. A method of assisting a subject in selecting at least one beauty product, the method comprising:
maintaining a plurality of sets of time-lapse body images for a plurality of individuals;
associating with each of the plurality of sets of time-lapse body images an identity of at least one beauty product used by each of the plurality of individuals during the time-lapse;
receiving selection information for matching the subject with at least one individual portrayed in a maintained set of time-lapse body images;
displaying to the subject the at least one set of time-lapse body images of the at least one individual; and
presenting to the subject an identification of at least one beauty product used during the time-lapse by the at least one individual.

2. The method of claim 1, further comprising maintaining personal information about each of the plurality of individuals.

3. The method of claim 2, further comprising presenting to the subject personal information about at least one of the plurality of individuals.

4. The method of claim 2, wherein maintaining personal information includes maintaining at least one of age information, lifestyle information, demographic information, environmental exposure information, nutritional habits, medical history information, beauty product use information, and dietary supplement use information.

5. The method of claim 1, further comprising providing the subject with information on how to purchase the at least one beauty product.

6. The method of claim 5 conducted at least in part over an electronic network, the method further comprising presenting to the user an offer to purchase the at least one beauty product and electronically receiving an order for the at least one beauty product.

7. The method of claim 1, wherein the time-lapse body images include facial images.

8. The method of claim 1, wherein the time-lapse body images include images of body parts.

9. The method of claim 1, wherein the at least one beauty product is chosen from anti-aging compounds, elasticity enhancers, hair coloring products, moisturizers, tanners, anti-wrinkle agents, blushes, mascaras, eyeliners, lip liners, lipsticks, lip glosses, eyebrow liners, eye shadows, nail polishes, foundations, concealers, dental whitening products, cellulite reduction products, shampoos, conditioners, hair straightners and curlers, and weight reduction products.

10. The method of claim 1, wherein maintaining the plurality of sets of time-lapse body images comprises assembling the time-lapse body images.

11. The method of claim 10, wherein the assembling comprises collecting the time-lapse images in a database.

12. The method of claim 1, wherein the time-lapse images for each individual are separated in time by a plurality of days.

13. The method of claim 1, wherein the time-lapse images for each individual are each separated in time by a plurality of weeks.

14. The method of claim 1, wherein the time-lapse images for each individual are each separated in time by a plurality of months.

15. The method of claim 1, wherein the time-lapse images for each individual are each separated in time by a plurality of years.

16. The method of claim 1, wherein the plurality of sets of time-lapse body images include time-lapse body images of at least some individuals who did not apply a specified beauty product during the time-lapse.

17. The method of claim 16, further comprising displaying to the subject time-lapse images of at least one of the at least some individuals.

18. The method of claim 1, wherein the time-lapse images of the plurality of individuals include actual images.

19. The method of claim 1, wherein the time-lapse images of the plurality of individuals include simulated images.

20. The method of claim 1, further comprising, associating with each image a relative time frame, and advising the subject of the time frame associated with each image displayed to the subject.

21. The method of claim 1, wherein receiving selection information includes receiving information about at least one beauty product for which the subject expresses an interest.

22. The method of claim 21, further comprising displaying to the subject a list of individuals who have used the at least one beauty product.

23. The method of claim 1, wherein receiving selection information includes receiving information about an external body condition for which the subject expresses an interest.

24. The method of claim 23, further comprising displaying to the subject a list of individuals with the external condition for which the subject expresses an interest.

25. The method of claim 1, wherein receiving selection information includes receiving answers to a series of personal questions, and identifying similarities between answers to the series of questions and personal information about at least one individual from the plurality of individuals.

26. The method of claim 1, further comprising displaying to the subject a gallery of images.

27. The method of claim 1, further comprising displaying to the subject a gallery of images of individuals who share characteristics with the subject.

28. The method of claim 1, further comprising displaying to the subject a treatment regimen of the at least one individual.

29. A system for assisting a subject in selecting at least one beauty product, the system comprising:
a memory including a program that
maintains a plurality of sets of time-lapse body images for a plurality of individuals,
associates with each of the plurality of sets of time-lapse body images an identity of at least one beauty product used by each of the plurality of individuals during the time-lapse,
receives selection information for matching the subject with at least one individual portrayed in a maintained set of time-lapse body images,
displays to the subject the at least one set of time-lapse images of the at least one individual, and
presents to the subject an identification of at least one beauty product used during the time-lapse by the at least one individual; and
a processor that runs the program.

30. A computer-readable medium containing instructions for causing a computer to perform a method of assisting a subject in selecting at least one beauty product, the method comprising:
maintaining a plurality of sets of time-lapse body images for a plurality of individuals;
associating with each of the plurality of sets of time-lapse body images an identity of at least one beauty product used by each of the plurality of individuals during the time-lapse;
receiving selection information for matching the subject with at least one individual portrayed in a maintained set of time-lapse body images;
displaying to the subject the at least one set of time-lapse images of the at least one individual; and
presenting to the subject an identification of at least one beauty product used during the time-lapse by the at least one individual.

31. A computer for assisting a subject in selecting at least one beauty product, the computer comprising:
means for maintaining a plurality of sets of time-lapse body images for a plurality of individuals;
means for associating with each of the plurality of sets of time-lapse body images an identity of at least one beauty product used by each of the plurality of individuals during the time-lapse;
means for receiving selection information for matching the subject with at least one individual portrayed in a maintained set of time-lapse body images;
means for displaying to the subject the at least one set of time-lapse images of the at least one individual; and
means for presenting to the subject an identification of at least one beauty product used during the time-lapse by the at least one individual.

32. The computer of claim 31, further comprising means for maintaining personal information about each of the plurality of individuals.

33. The computer of claim 32, wherein personal information includes at least one of age information, lifestyle information, demographic information, environmental exposure information, nutritional habits, medical history information, beauty product use information, and dietary supplement use information.

34. The computer of claim 31, wherein the time-lapse body images include facial images.

35. The computer of claim 31, wherein the time-lapse body images include images of body parts.

36. The computer of claim 31, wherein the beauty product is chosen from anti-aging compounds, elasticity enhancers, hair coloring products, moisturizers, tanners, anti-wrinkle agents, blushes, mascaras, eyeliners, lip liners, lipsticks, lip glosses, eyebrow liners, eye shadows, nail polishes, foundations, concealers, dental whitening products, cellulite reduction products, shampoos, conditioners, hair straightners and curlers, and weight reduction products.

37. The computer of claim 31, wherein the time-lapse images for each individual are separated in time by a plurality of days.

38. The computer of claim 31, wherein the time-lapse images for each individual are each separated in time by a plurality of weeks.

39. The computer of claim 31, wherein the time-lapse images for each individual are each separated in time by a plurality of months.

40. The computer of claim 31, wherein the time-lapse images for each individual are each separated in time by a plurality of years.

41. A method of assisting a subject to determine how personal experience might impact at least one external condition of the subject, the method comprising:
collecting subject information about at least one external condition of the subject;
generating a prognosis for the subject based on the subject information;
presenting to the subject information about experiences of at least one individual having a prognosis similar to the prognosis of the subject, the information including at least one of lifestyle information, age, skin type, and skin tone and beauty product usage information; and
presenting to the subject time-lapse images of the at least one individual.

42. The method of claim 41, wherein the at least one individual is a person who previously used the beauty product.

43. The method of claim 41, wherein the beauty product is chosen from skin care products and hair care products.

44. The method of claim 41, wherein the beauty product is chosen from anti-aging compounds, elasticity enhancers, hair coloring products, moisturizers, tanners, anti-wrinkle agents, blushes, mascaras, eyeliners, lip liners, lipsticks, lip glosses, eyebrow liners, eye shadows, nail polishes, foundations, concealers, dental whitening products, cellulite reduction products, shampoos, conditioners, hair straightners and curlers, and weight reduction products.

45. A system for assisting a subject to determine how personal experience might impact at least one external condition of the subject, the system comprising:
a memory including a program that
collects subject information about at least one external condition of the subject,
generates a prognosis for the subject based on the subject information,
presents to the subject information about experiences of at least one individual having a prognosis similar to the prognosis of the subject, the information including at least one of lifestyle information, age, skin type, and skin tone and beauty product usage information, and
presents to the subject time-lapse images of the at least one individual; and
a processor that runs the program.

46. A computer-readable medium containing instructions for causing a computer to perform a method of assisting a subject to determine how personal experience might impact at least one external condition of the subject, the method comprising:
collecting subject information about at least one external condition of the subject;
generating a prognosis for the subject based on the subject information;
presenting to the subject information about experiences of at least one individual having a prognosis similar to the prognosis of the subject, the information including at least one of lifestyle information, age, skin type, and skin tone and beauty product usage information; and
presenting to the subject time-lapse images of the at least one individual.

47. A computer for assisting a subject to determine how personal experience might impact at least one external condition of the subject, the computer comprising:
means for collecting subject information about at least one external condition of the subject;
means for generating a prognosis for the subject based on the subject information;
means for presenting to the subject information about experiences of at least one individual having a prognosis similar to the prognosis of the subject, the information including at least one of lifestyle information, age, skin type, and skin tone and beauty product usage information; and
means for presenting to the subject time-lapse images of the at least one individual.

48. A method of assisting a subject in determining how personal experience might impact at least one external condition of the subject, the method comprising:
collecting subject information about at least one external condition of the subject;
based on the collected subject information, selecting a record of experiences of at least one other individual whose record contains information relating to the at least one external condition; and
presenting to the subject information from the selected record, the information including personal experience of the at least one other individual.

49. The method of claim 48, wherein the presented personal experience of the at least one other individual is textually presented as a story about life experiences of the at least one other individual.

50. The method of claim 48, conducted, at least in part, in a network environment, wherein the record is selected from a database located remote from the subject, and wherein the presented information from the selected subject record is transmitted over a network for viewing by the subject.

51. A method of assisting a subject in selecting at least one beauty product, the method comprising:
maintaining a plurality of sets of time-lapse information for a plurality of individuals;
enabling the subject to select at least one of said plurality of individuals;
displaying to the subject at least one set of time-lapse information corresponding to the at least one selected individual; and
displaying to the subject personal information about a lifestyle of the at least one selected individual.

52. The method of claim 51, wherein the personal information about a lifestyle is textually presented in a form of a story about life experiences of the at least one selected individual.

53. The method of claim 51, conducted, at least in part, in a network environment, wherein the time-lapse information is maintained in a database located remote from the subject, and wherein the personal information about a lifestyle of the at least one selected individual is transmitted over a network for display to the subject.

54. A method of assisting a subject in determining how personal experience might impact the subject's appearance, the method comprising:
maintaining a plurality of sets of time-lapse body information for a plurality of individuals;
enabling the subject to select at least one of the individuals; and
displaying to the subject the time-lapse body information relating to the at least one selected individual.

55. The method of claim 54, further comprising displaying to the subject personal information about the at least one selected individual, at least some of the personal information being a textual presentation about life experiences of the at least one selected individual.

56. The method of claim 54, conducted, at least in part, in a network environment, wherein the time-lapse information is maintained in a database located remote from the subject, and wherein displaying to the subject occurs at a location remote from the subject.
